(19) United States
(12) Patent Application Publication
(10) Pub. No.: US 2026/0050615 A1
(43) Pub. Date: Feb. 19, 2026

(54) IDENTIFYING RELEVANCE OF DOCUMENTS FOR AUTOMATED RETRIEVAL MODELS USING LARGE LANGUAGE MODELS

(71) Applicant: PAYPAL, INC., San Jose, CA (US)

(72) Inventors: Soujanya Lanka, Singapore (SG); Zehong Ma, Shanghai (CN); Ramprasad Balaji, Bengaluru (IN)

(21) Appl. No.: 19/278,461

(22) Filed: Jul. 23, 2025

Related U.S. Application Data
(63) Continuation of application No. 18/806,529, filed on Aug. 15, 2024, now abandoned.

(51) Int. Cl. G06F 16/332; G06F 16/3329

(52) U.S. Cl. CPC G06F 16/3326; G06F 16/3329

(57) ABSTRACT

There are provided systems and methods for identifying relevance of documents for automated retrieval models using large language models. An online transaction processor or other service provider may provide computing services and platforms to entities, which may include chatbots, information retrieval systems, question-and-answer systems, and the like. To provide better retrieval model training and refinement, the service provider may generate training data from user interaction logs, which may include user feedback that may be used to determine if documents are relevant to queries, and therefore should be retrieved for answering those queries by automated retrieval models. An LLM may be used as a judge to determine whether chatbot responses reference certain document. If not references, the query may be analyzed to determine whether certain retrieved documents are relevant. Data pairs may be generated for the training data from these processes and used for model refinement.

### CROSS REFERENCE TO RELATED APPLICATIONS

This application is a continuation of U.S. patent application Ser. No. 18/806,529, filed Aug. 15, 2024, the contents of which are hereby incorporated by reference in their entirety for all purposes.

### TECHNICAL FIELD

The present disclosure relates generally to artificial intelligence (AI) and machine learning (ML) systems and models, and more specifically to fine-tuning of large language models (LLMs) for responding to queries and requests for domain-specific tasks.

### BACKGROUND

LLMs are widely used in enterprise applications due to their generalized natural language processing (NLP) capabilities. Chatbots and other automated conversational systems that implement LLMs may utilize Retrieval Augmented Generation (RAG) to provide assistance to LLMs outside their training and knowledge base, such as based on domain knowledge or other authoritative knowledge base that may be important to the user questions and queries to the LLM systems. RAG may therefore assist with optimizing the output of LLMs by referencing and retrieving information, documents, and other knowledge from a particular corpus of documents, system, database, or other knowledge source before the LLM generates a response, thereby providing additional context, information, and the like for automated LLM response generation and processing. RAG-based bots, modules, and systems may function using two components, a document retriever that retrieves “relevant” documents (as determined by training, scoring, ranking, or the like) and an answer generator that generates answers based on the retrieved documents, as well as other LLM training.

A central challenge encountered in this LLM and RAG-based infrastructure is the limited facility for continuous improvement of the retriever module based on user feedback. Contrary to a traditional search system where user interactions, such as document clicks, approval/disapproval of results (e.g., thumbs up/down to search results of the documents), and the like, indicate the user's preference and relevance of the results to the search query, RAG bot systems do not have and/or process such feedback. For example, in a RAG bot system, the user does not directly interact with the retrieved documents. The user sees only the final response from the bot, which creates difficulty with receiving direct feedback on whether the retrieved document was relevant to their query. Despite adopting a practice of collecting data on user satisfaction levels, the lack of direct feedback linking the relevance of the user's query with the selected document presents a significant obstacle. Consequently, services providers, search systems, and other providers of RAG bots do not have a clear mechanism to refine the retriever model based on user interactions and feedback and therefore it is desirable to provide a system to collect and incorporate user feedback from retrieved documents in such bots and AI systems to improve LLM and RAG bot efficiency and accuracy, while reducing operational costs and computing resource usage for fine-tuning and retraining.

### BRIEF DESCRIPTION OF THE DRAWINGS

FIG. 1 is a block diagram of a networked system suitable for implementing the processes described herein, according to an embodiment;

FIGS. 2A-2B are exemplary diagrams of a service provider's systems that are utilized to provide and refine document retrieval models of RAG based systems and models, according to an embodiment;

FIG. 3 is an exemplary diagram of training data generation for RAG model refinement based on user feedback, according to various embodiments;

FIG. 4 is a flowchart for identifying relevance of documents for automated retrieval models using large language models, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for identifying relevance of documents for automated retrieval models using large language models. Systems suitable for practicing methods of the present disclosure are also provided.

A service provider, such as an online transaction processor, may provide computing services to users and/or their corresponding entities, which may include end users and customers, merchant customers of an online transaction processor, businesses and their representatives and/or employees, and the like. These computing services may include those associated with electronic transaction processing, payments, digital account usage, peer-to-peer transfers and payments, and the like. With these computing services, automated help or assistance may be provided through chatbots in an email channel, a digital alert channel, a text message channel, a push notification channel, an instant message channel, or the like. These chatbots and other automated computing processes may allow end users of a service provider to engage in self-service assistance options associated with one or more services of the service provider. For example, an online transaction processor may provide automated assistance options for account setup, authentication, account usage (e.g., during electronic transaction processing), mobile device or application usage, payment information and/or service, and the like. These automations for self-service options provide assistance via chat sessions and automated chat dialogs and other communication through different electronic communication channels. A conversational AI platform or system may be used to converse with users, which may include LLMs, RAG bots and modules, ML models, NNs, and other AI systems for conversing with users. For example, an LLM may be used to respond to users in a conversational manner, where RAG-based bots and operations may retrieve additional knowledge and information, such as domain-specific documents and/or information for a specific context, to steer responses of the LLM to certain knowledge, documents, domain contexts, and the like.

Conversations between chatbots and users during chat sessions may include users submitting questions or requests, such as by querying or commanding the chatbots, and receiving corresponding answers or responses. However, LLMs are generalized in nature and respond from an initial corpus of documents used to provide their NLP capabilities. The effectiveness of a Retrieval Augmented Generation (RAG) bot relies on two components, a document retriever and an answer generator. Given a user's input query, the document retriever selects the top-k most pertinent documents from the collection. Subsequently, these documents, together with the query, are forwarded to the answer generator for articulating a comprehensive response. With this process, the bot system may further attempt to minimize the phenomenon of “hallucinations” in the answer generator, which may correspond to content and data that is “made up,” irrelevant, inconsistent with the input and/or training data, or otherwise unhelpful or harmful for the response. This may stem from factors that occur during training and/or with the training data, such as source-reference divergence, biased training data, redacted or privacy protected data, issues with decoding or transforming data, and the like. This minimization of hallucinations thereby yields more coherent and appropriate responses. The retriever's proficiency plays a decisive role in this framework by providing correct and accurate documents for answer generation by an LLM or other conversational AI of the RAG bot. Failing to recover pertinent documents may lead the answer generator to deliver inaccurate responses or hallucinate since it lacks the necessary reference material.

To provide improved LLMs and RAG bots and modules through document relevance, an LLM and/or RAG bot refinement and/or finetuning system may, in some embodiments, be provided and/or utilized by the service provider to identify document relevance through an “LLM-as-a-judge” process with user feedback to LLM responses. In this regard, LLMs and LLM chatbots may be used with the different computing services provided by a service provider, such as to provide automated customer service during computing service usage. In order for users to utilize computing services of the service provider, the service provider (e.g., an online transaction processor, such as PAYPAL®) may require users and other entities requesting the services to have an account with the service provider. A user wishing to establish an account may first access the online service provider and request establishment of the account. When establishing accounts, login and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments. Further, the user may stablish, purchase, trade, and/or store cryptocurrency (e.g., through storage, exchange, and/or use of private keys for cryptocurrency values, tokens, or digital currency).

The user may also be required to provide financial information, including payment card (e.g., credit/debit card) information, bank account information, gift card information, benefits/incentives, and/or financial investments, which may be used to process transactions for items. The account creation may be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of a user is established with the service provider, the user may utilize the account via one or more computing devices, such as a personal computer, tablet computer, mobile smart phone, or the like. The user may engage in one or more online or virtual interactions that may be associated with electronic transaction processing, images, music, media content and/or streaming, video games, documents, social networking, media data sharing, microblogging, and the like. Similarly, the merchants may use the accounts when providing their merchant services to customers, such as during electronic transaction processing. As such, different users may engage in one or more online or virtual interactions, such as browsing websites and data available with websites of merchants. In this regard, the transaction processor or other online service provider may offer and provide computing services through data processing of account and transaction data for electronic transaction processing, as well as other data processing services for other use of computing services on websites, applications, or other online portals of the merchant.

For example, a service provider may provide an autonomous agent and/or chatbot to assist users with computing service usage and enhance the efficiency of various analytical tasks during assistance and/or automated conversational usage of computing services. These automated chatbot systems may rely on LLM services, which may provide conversational responses to users. These LLM services may include RAG bots that may provide document retrieval and response generation. For example, a service provider may incorporate a RAG bot and/or refinement system employing an LLM as an automated judge to assist in discerning the relevance of a document to a user's query. The evaluation is based on the user's satisfaction score with RAG bot's response. To determine the relevance of a document, the following steps may be used when determining the data used for the document evaluation. First, data for analysis may be extracted from user interaction logs, which may contain the bot's responses, corresponding user queries, and the top-k retrieved documents used for generating and/or providing the bot's responses. Second, a subset from the extracted log data may be selected and annotated in a data pair or other format for analysis, such as a data pair having: (document, response), along with a relevancy label expressed as a binary label (e.g., 1 or 0) or the like including scalers and/or fractional points to identify partial relevancy. This data set of the corresponding pairs or other annotated data records may be used for LLM calibration, which may aim to align the model output with expectations for such outputs. The calibration may be either a prompt update or supervised fine-tuning of the LLM. However, this step may be optional and bypassed if a zero-shot LLM prompt or other similar LLM prompting strategy is instead selected, such as if such a prompt strategy exhibits satisfactory performance without prompt engineering/updating and/or supervised fine-tuning.

During a third step, the data set may be analyzed and/or annotated for LLM input based on each type of data in the data set. For example, the data set collected from the user interaction logs may include three types of data to process and handle, although other data sets may have more, less, or different data types. The data types may include “satisfying responses” that represent high user satisfaction scores and/or a positive user response, which indicate that the bot's response aptly answers the user's query. With a RAG architecture, this response likely cites one or more of the retrieved documents. In this context, an input pair, (bot response, document), may be inputted to the LLM. Using a designed prompt, the LLM may then evaluate if the document is referred to in the bot's response, which, if so, renders the document relevant to the user's query. Relevant documents may correspond to and/or be designated or identified as documents that an LLM and/or a user (e.g., a data scientist) may designate or identify as being useful or informative for responding to a query, such as those that may include source or knowledge material and information for a query. Such documents may be found in the top-k documents for a query and may include a “gold” or source document used for responding to the query. A gold document may be labeled as such by a data scientist, analyst, annotator, or the like, or may be determined by the LLM based on a highest relevancy of the documents.

The data set from the user interaction logs may further include “unsatisfying responses” or negative user responses indicating that the bot's response did not adequately address the user's query. This may suggest that the retrieved documents are likely not relevant to the user's query. These may also be input to an LLM for the LLM to evaluate if the document is or is not referred to in the bot's response, which may indicate the overall relevance of the document to the user's query (e.g., if not referenced, may further indicate the document is relevant to the query as it was referenced in the response. However, if referenced in the response, may indicate the document is not relevant as the response was unsatisfactory).

Finally, there may be data without user feedback, such as an unknown user response. In such instances, the responses relevance to the user's query must be inferred to process such responses. This process may involve a combination of LLM judgment, monitoring outcomes (e.g., checking if the user continues to reach out to the customer agent after interacting with the bot), and/or conducting human expert checks. After identifying the data pairs, points, or the like according to their data types in the data set, the data from each corresponding category are then directed through the RAG refinement pipeline based on their determined and/or inferred satisfaction grade.

Fourth, to determine the data for the evaluation, the process may collect positive response pairs, (user query, relevant doc), and negative response pairs (user query, not-relevant doc). Positive pairs may yield high accuracy rates since the bot responses often quote content from the corresponding relevant document. As such, the LLM being used as a reviewer may predict this scenario with relative case by analyzing the response and the relevant document. Negative pairs, however, may contain documents relevant to the user's query, but are not directly quoted by the bot's response, such as references via uniform resource locators (URLs). To eliminate potential noise in the negative pairs, the negative pairs may be provided and input to the LLM, which may then judge the relevance of documents to the user query (in contrast to the bot's response in step three). Only pairs with negative results in both models are maintained as negative samples, such as those pairs that the LLM determines the document is not referenced in the response and also not relevant to the user's query.

In a last fifth step for training data generation that may be used for RAG bot refinement, fine-tuning, and/or retraining, this data is collected and the positive samples and filtered negative samples may serve as training data for model iteration. The RAG bot refinement system may then proceed to refine, retrain, and/or fine-tune the retrieval model for document retrieval, which may therefore improve the LLM system's capabilities in identifying relevant documents based on user feedback. In contrast, conventional present solutions for a RAG chatbot are primarily directed to enhancing the quality of the answer generation module. As such, these solutions do not focus on utilizing user feedback for refinement of the document retriever module, which affects bot performance. As such, the processes to generate the aforementioned training data for RAG bot refinement and LLM training deviates significantly from existing refinement methodologies by leveraging user feedback through employing an LLM to assess whether a particular document is relevant to a user's query or not. As such, this facilitates the creation of highly relevant, positive data pairs, as well as filtered negative data pairs for model training and refinement. These data pairs and training data set may be utilized for continuous improvement and refinement of the automated retrieval model, thereby improving the overall quality and performance of the RAG bot system and other AI systems. This use of LLM-as-a-reviewer to process user satisfaction feedback for the improvement of the retrieval model in RAG bots therefore provides an improved technical solution for automated chatbot technologies. As such, the intelligent LLM and RAG bot refinement framework may provide a more efficient, automated, and accurate RAG bot for document retrieval and/or question answering in chatbot systems and environments.

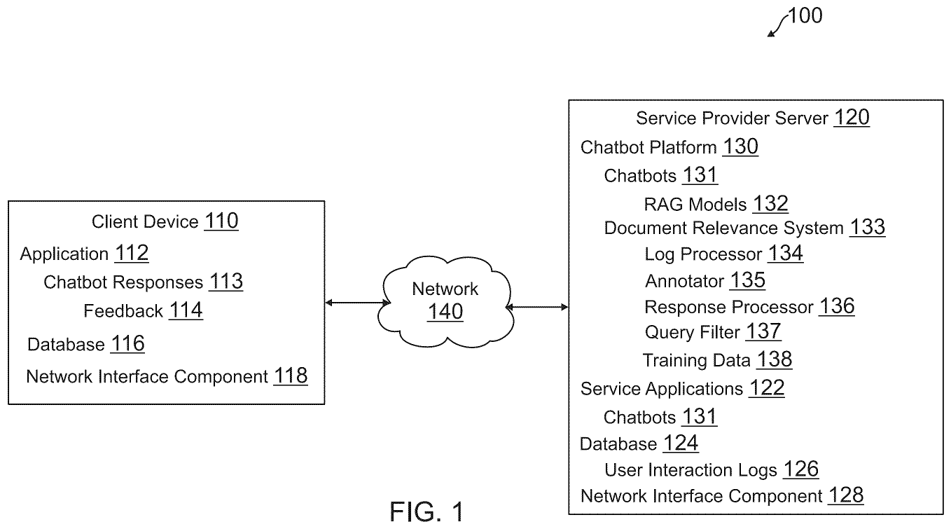

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by an entity or a user (including merchants, end-users, businesses, etc.), such as a customer of service provider server 120, to receive communications over network 140, where service provider server 120 may provide various data, operations, and other functions over network 140 to provide services to merchants, users, and computing devices. In this regard, client device 110 may be used with various chatbots and conversational Als that may utilize LLMs with RAG bots for document retrieval and answer generation using refinement processes based on training data generation by service provider server 120, as discussed herein.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device of an investigator, agent, or other internal user associated with service provider server 120. Client device 110 may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. The application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for users to utilize with service provider server 120, such as to provide access to and use of computing services provided by service provider server 120. This may include the use of and/or interaction with the computing services of service provider server 120 provided through chatbots and conversational Als. In this regard, application 112 may correspond to specialized software utilized by a user of client device 110 to generate and transmit a request for a response to a chatbot that may utilize an LLM system incorporating a RAG bot for document retrieval and answer generation. In some embodiments, the request may specify a computing service, chatbot, LLM, or the like, and may include a question or query to the chatbot. Application 112 may also be utilized to review and address responses to questions and queries, such as when receiving chatbot responses 113. Chatbot responses 113 may be generated by an LLM and RAG bots/models of service provider server 120.

Application 112 may further be used to review, revise, and/or provide feedback 114 on AI generated conversational dialogue, such as chatbot responses 113, from service provider server 120. In this regard, feedback 114 may indicate whether chatbot responses 113 are correct, identify correct documents, include hallucinations, or are otherwise helpful and useful or not helpful, do not cite or include proper or correct documents, and the like. Thus, feedback 114 may indicate whether each of chatbot responses 113 are acceptable/satisfactory or unacceptable/unsatisfactory. This may be used when refining the RAG bot for more accurate document retrieval, as discussed herein. As such, feedback 114 may be processed by an LLM and utilized to generate training data for model refinement of RAG bots and other LLM components.

Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider server 120 or other entity that may interact with service provider server 120 during computing service usage. Thus, application 112 may also correspond to different service applications and the like. When utilizing application 112 with service provider server 120, application 112 may transmit a request for one or more of chatbot responses 113 and receive chatbot responses 113 to such prompts, questions, or queries for an LLM and/or chatbot. Feedback 114 may then be provided in return, which may be processed by service provider server 120.

Client device 110 includes other applications as may be desired to provide features to client device 110. For example, these other applications may include security applications for implementing client-side security features, programmatic client applications for interfacing with appropriate application programming interfaces (APIs) over network 140, or other types of applications. Other applications on client device 110 may also include email, texting, voice and IM applications that allow a user to send and receive emails, calls, texts, and other notifications through network 140. In various embodiments, the other applications may include those that may be utilized in the course of LLM training, training data curation and/or annotation, and/or LLM FT. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120.

Client device 110 includes at least one network interface component 118 adapted to communicate with service provider server 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services and operations via one or more digital platforms, applications, websites, and the like. Service provider server 120 may provide computing services to various entities, which may include computing services provider to internal and/or external users. As such, during the course of service provision, service provider server 120 may provide automated operations for conversational chat sessions using chatbots that utilize LLMs with RAG bots refined and trained using the operations and training data generation discussed herein. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes and/or is associated with a chatbot platform 130, service applications 122, a database 124, and a network interface component 128, implementations of which are discussed further below. Chatbot platform 130 and service applications 122 may correspond to executable processes, procedures, and/or applications with associated hardware. In other embodiments, service provider server 120 may include additional or different modules having specialized hardware and/or software as required.

Chatbot platform 130 may correspond to one or more processes to execute modules and associated specialized hardware of service provider server 120 to provide a chatbots 131 including RAG models 132 that may include one or more applications, operations, and/or components for chatbots, conversational Als, and other AI components for automated conversational service by service provider server 120 with service applications 122. In this regard, chatbot platform 130 may correspond to specialized hardware and/or software used by an internal agent, data scientist, administrator, or other user associated with client device 110 to create, deploy, and refine chatbots 131, such as by generating training data for RAG models 132 based on feedback 114. As such, data scientists and other model training teams may train LLMs and RAG models 132 for chatbots 131, including one or more LLMs, AI or ML models, NNs, conversational AIs, or the like.

Chatbots 131 may utilize RAG models 132 during the course of responding to questions and queries, such as those from client device 110, which may include conversational AIs having trained layers based on training data and selected features or variables configured to generate conversation or dialogue for chat assistance, such as when using or requiring assistance for service applications 122. For example, ML features may correspond to individual pieces, properties, characteristics, or other inputs for an ML model and may be used to cause an output by that ML model once the ML model has been trained using data for those features from training data. Chatbots 131 may be used for intelligent conversational outputs based on training on a set of documents, such as one or more corpora of general and/or domain documents. As such, ML models including LLMs may be trained to provide predictive outputs, such as a response, score, likelihood, probability, or decision, associated with a particular prediction, classification, or categorization. RAG models 132 may provide more granular and/or domain-specific document retrieval to provide knowledge from a specific knowledge domain, set or corpus of documents, database, or the like, which may allow for more specific LLM responses. As such, RAG models 132 may include a retrieval model and an answer generator, where the retrieval model may be used to specifically select n-top documents or other data from a particular domain, corpus of documents, database, etc., based on training and refinement, as discussed herein. This may include training and/or refinement using training data generated from feedback 114 and other user feedback and information.

For example, chatbots 131 may include deep neural networks (DNNs), MLs, generative AIs, LLMs, or other AI models, such as RAG models 132, trained using training data having data records that have columns or other data representations and stored data values (e.g., in rows for the data tables having feature columns) for the features. When building chatbots 131 and/or RAG models 132, training data may be used to generate one or more classifiers and provide recommendations, predictions, or other outputs based on those classifications and an ML or NN model algorithm and architecture. For example, with LLMs and/or RAG models 132, training data may correspond to different corpora of documents and information, which may then allow the models to respond intelligently based on learning for such corpora. The algorithm and architecture for the chatbots 131 and/or RAG models 132 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records. Thus, when chatbots 131 and/or RAG models 132 are used to perform a predictive analysis and output, such as queried or questioned for a conversational response, the input data may be processed to provide a corresponding output based on the trained classifications.

Layers, branches, clusters, or the like of the chatbots 131 and/or RAG models 132 may be trained by using training data associated with data records of interest, such as general or domain-specific documents. This may include domain knowledge based on and/or domain documents for the computing service provided and/or managed by service provider server 120 including one or more of service applications 122. In this regard, for training chatbots 131 and/or RAG models 132, corpora of documents associated with general knowledge documents and/or domain-specific documents. By providing training data, the nodes in the hidden layer may be trained (adjusted) such that an optimal output (e.g., a classification) is produced in the output layer based on the training data. By continuously providing different sets of training data and/or penalizing the chatbots 131 and/or RAG models 132 when the outputs are incorrect, chatbots 131 and/or RAG models 132 (and specifically, the representations of the nodes in the hidden layer) may be trained (adjusted) to improve its performance in data classifications and predictions. Adjusting of chatbots 131 and/or RAG models 132 may include adjusting the weights associated with each node in the hidden layer. With RAG models 132, refinement may be implemented to train and/or retrain their retrieval models based on user feedback, such as feedback 114 to chatbot responses 113.

As such, adjusting chatbots 131 may also include retraining and/or refinement of RAG models 132, such as using the training data automatically generated from user feedback discussed herein in place of conventional manual and/or human efforts for training data generation. In this regard, a document relevance system 133 may be implemented to determine document relevance to user queries and questions, which may be used to indicate and/or annotate response effectiveness, efficacy, and user satisfaction, as well as identify top-k documents and train for better or more accurate document retrieval. Document relevant system 133 may include a log processor 134, which may initially extract data for user queries and bot responses from user interaction logs 126, such as chat data and/or chat sessions by users and devices with chatbots 131 and identify the top-k retrieved documents by RAG models 132 for those responses. After data extraction by log processor 134, an annotator 135 may annotate the response by generating data pairs and/or annotated data samples having a (document, response) format with a relevancy label of the document to the response. This may be optional and may be based on feedback 114 and/or other user comments to chatbot responses 113 and/or other conversational responses by chatbots 131. These data pairs or other annotated data may be used for LLM calibration of the LLMs utilized during further training data generation for refinement of RAG models 132.

A response processor 136 may then be used for processing responses to determine whether those responses satisfactorily answered, based at least in part on feedback 114, the user query based on the relied upon and retrieved document(s). Response processor 136 may generate, from prompting an LLM with chatbot responses 113 and feedback 113, data pairs (e.g., in the format of (response, document(s)) for satisfying responses and their corresponding document that the user found satisfying, unsatisfying pairs and the retrieved documents that did not answer the user's query (or were found lacking by the user), and data without user feedback. The LLM may be prompted with the chat logs and other interaction data to determine and/or decipher the user's feedback as to the satisfaction of responses, which may be used to generate such data pairs. With a query filter 137, data pairs (e.g., in the format of (query, document(s)) may be generated for positive pairs and filtered negative pairs. Similarly, an LLM may be prompted to determine, from the user queries and feedback, which documents may be relevant and those that may not be relevant. With filtered negative pairs, the LLM used by query filter 137 may judge the relevant of documents, and only those data pairs that both have retrieved documents used in an unsatisfying response and not relevant to the query may be used.

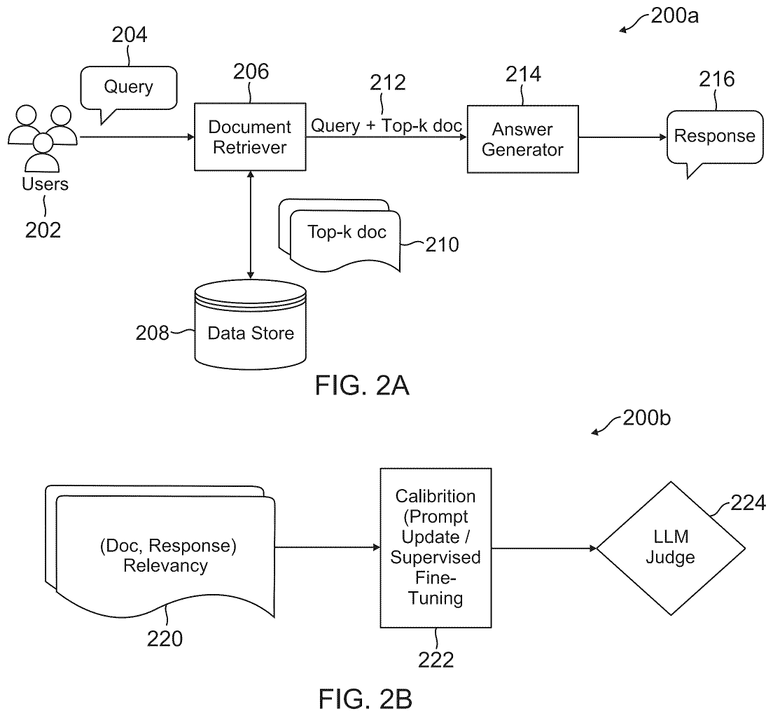

As a result, training data 138 may be generated from the different data pairs, which may be used for refinement of RAG models 132. Training data 138 may include data pairs for “relevant” documents to queries (e.g., (query, relevant document)) and the data pairs for non-relevant documents after filtering (e.g., (query, not relevant document)). Document relevant system 133 may assist in training and/or refinement of chatbots 131 for better accuracy and improved reliability (e.g., less hallucinations) when responding to user queries using RAG models 132. The operations of document relevant system 133 are discussed in more detail below with regard to FIGS. 2A-4.

Service applications 122 may correspond to one or more processes to execute modules and associated specialized hardware of service provider server 120 to process a transaction and/or provide other computing services to users. For example, service applications 122 may be used to process payments and other services to one or more users, merchants, and/or other entities for transactions, where chatbot platform 130 may be used for model training and refinement of chatbots 131 including RAG models 132. In this regard, accounts of users and entities may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

Further, service applications 122 may provide different computing services, including social networking, microblogging, media sharing, messaging, business and consumer platforms, etc. These computing services may be used by customers and users, and therefore chatbots 131 may be used to provide assistance and other conversational services utilized during the provision of computing services to users and devices. In this regard, chatbots 131 may answer queries and questions from users by providing responses based on top-k documents retrieved using RAG models 132, where the responses may be domain-specific and based on retrieved documents to provide improved accuracy and helpfulness of automated response generation. As such, document relevant system 133 may be used for training data generation and refinement of RAG models 132 to provide more accurate and reliable responses with less hallucinations including responses that rely on and/or identify domain-specific documents.

Service applications 122 as may provide additional features to service provider server 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 140.

Additionally, service provider server 120 includes or may access database 124. Database 124 may store various identifiers associated with client device 110. Database 124 may also store account data, including payment instruments, financial information, account balances, and authentication credentials, as well as transaction processing histories and data for processed transactions. Database 124 may include information used during AI conversational service provision by chatbots 131 and the like, such as chatbot response 113 and feedback 114, as well as training data 138 generated from such data for model refinement and retrieval model improvement. Database may also store user interaction logs 126 that include may be processed by log processor 136 for generation of training data 138, such as online chat sessions, email communications, text messages, search queries and response, and the like. As such, user interaction logs 126 may include logs of interactions, conversations, queries, responses, and feedback between users and chatbots 131. Although database 124 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIGS. 2A-2B are exemplary diagrams 200a and 200b of a service provider's systems that are utilized to provide and refine document retrieval models of RAG based systems and models, according to an embodiment. Diagrams 200a and 200b may include components of service provider server 120 for refinement of RAG bots based on user feedback to chatbot responses, as discussed in reference to system 100 of FIG. 1. In this regard, diagrams 200a and 200b show processes for document retrieval and initial LLM calibration for training data generation, which may use automated approaches without or with minimal human input.

In diagram 200a of FIG. 2A, a system is shown that may be used to respond to user queries using a RAG bot, which may implement LLM functions and/or operations for conversational dialogue and answer generation. In this regard, diagram 200a shows a RAG bot system that may be refined for improved document retrieval using the training data processes described herein. For example, in a conversational AI system, such as one that may utilize RAG bots for document retrieval and answer generation with LLM chatbots and the like, users 202 may submit different queries, such as a query 204 for a question that may be answered based on one or more documents or other knowledge accessible to the RAG bot for retrieval. The documents may correspond to domain knowledge and may be used initially when training an LLM for generalized chat responses or may be accessible by a trained RAG model when implementing a RAG bot that performs document retrieval and answer generation.

As such, a document retriever 206 may be utilized to perform initial document retrieval for answering and responding to query 204 in an automated manner through LLM chatbot services. Document retriever 206 may interface with a data store 208, such as a corpus of documents, including domain-specific documents, to retrieve top-k documents 210. Data store 208 may correspond to a database, database system, cloud storage, or other data storage component that may include different documents, which may be arranged in domains and/or corpora, or may be more generally stored and accessible for document retrieval by RAG bots including document retriever 206. Document retriever 206 may execute a retrieval model, such as a RAG-based AI model (e.g., ML model, NN, LLM, generative AI model, or the like) that may be used with data store 208 to process query 204 and determine top-k documents 210. Document retriever 206 may be refined and trained using the training data generated as described herein to incorporate user feedback.

Document retriever 206 may then provide query-document pairs 212 having query 204 with top-k documents 210 to an answer generator 214. Answer generator 214 may correspond to an LLM or other conversational AI that may then generate responses to queries, questions, and other prompts from users 202 in a conversational manner. As such, answer generator 214 may generate answers using a knowledge base from which the LLM or other conversational AI is initially trained, as well as top-k documents 210. Answer generator 214 may synthesize a response 216 based on query 204 and corresponding documents retrieved from top-k documents 210, and may provide response 216 via a chatbot to one or more of users 202 submitting or requesting answering of query 204. In this regard, response 216 may correspond to a chatbot response configured to answer query 204. Response 216 may then be analyzed for feedback, which may be utilized during retraining and/or refinement of the retrieval model for document retriever 206.

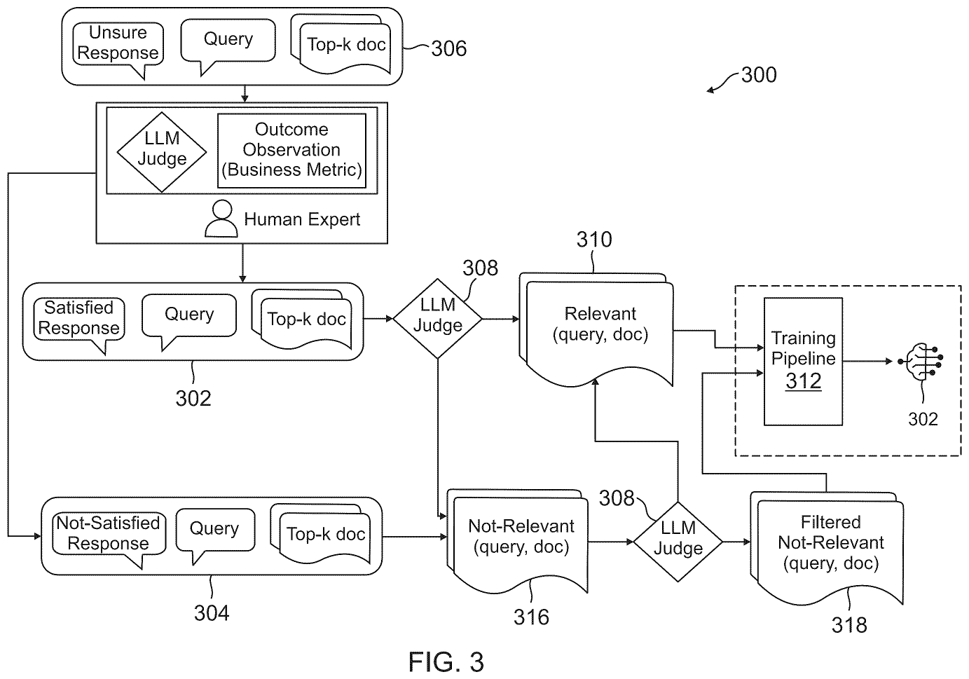

Referring now to FIG. 2B, diagram 200b shows a system for LLM calibration when generating training data for user feedback to bot responses, which may be used for RAG bot refinement. In this regard, initially user interaction logs of interest are selected and identified for use in training data generation, such as those logs that may include user feedback to bot responses. The bot responses may have resulted from chatbots interactions with users, such as LLM generated responses that may utilize RAG bots for document retrieval. In this regard, data is extracted from the user interaction logs, and a subset of the data may be identified that includes relevancy labeled data pairs 220. Relevancy labeled data pairs 220 may indicate log data having the format of (document, response), and may include a relevancy label, such as a 0/1 binary label for non-relevant/relevant (or vice versa, depending on data configurations and labeling). Relevancy labeled data pairs 220 may then be input and provided to a calibration 222, which may correspond to a prompt update and/or a supervised fine-tuning of the LLM model for LLM prompting when determining document relevancy to user queries. Calibration 222 may be performed on an LLM judge 224, where LLM judge 224 may then be used, as shown in FIG. 3 below, for training data generation to refine a RAG bot and model for improved document retrieval.

FIG. 3 is an exemplary diagram 300 of training data generation for RAG model refinement based on user feedback, according to various embodiments. Diagram 300 represents training data generation for RAG bot refinement by document relevance system 133 of chatbot platform 130 provided by service provider server 120 in system 100 of FIG. 1. As such, diagram 300 shows by which training data may be generated from data pairs extracted from user interaction logs, which may include user feedback, using an LLM-as-a-judge to evaluate document relevancy.

In diagram 300, initially different data pairs for responses and document relevancy may be determined, such as satisfied data pairs 302, non-satisfied data pairs 304, and unsure response data pairs 306. With satisfied data pairs 302, high user satisfaction scores may be used to identify bot responses that aptly answer one or more user queries. In this regard, with a RAG architecture and bot, the response therefore likely cites one more of the top-k retrieved documents, which are considered relevant to the user's query. However, with unsatisfied data pairs 304, the bot's response is indicated as unresponsive to the user's query or did not adequately address the user's query. As such, this feedback indicates that the retrieved documents were likely not relevant to the user's query. Finally, there may be some unlabeled data and/or data without feedback, such as if the user does not initially provide feedback. As such, with unsure data pairs 306, the response's relevancy to the user's query may be inferred. This may be done through LLM judgment, monitoring outcomes of the user's query and/or bot's response (e.g., the user continuing to request help or a live agent, resolving their issue, etc.), and/or conducting human expert spot checks. After this, unsure response data pairs 306 may be classified within satisfied data pairs 302 or unsatisfied data pairs 304 for further processing.

Once properly classified and/or labeled, satisfied data pairs 302 and unsatisfied data pairs 304 may be processed using an LLM judge 308 to properly infer and judge whether a document from the retrieved documents is referred to in the bot's response, thereby rendering relevant or not relevant for satisfied data pairs 302 or unsatisfied data pairs 304, respectively. For example, LLM judge 308 may be prompted to determine and decide whether the response is referring to a document in the retrieved documents when providing the response to the user's query. This may be done for satisfied data pairs 302 by LLM judge 308 to generate relevant query-document pairs 310. Relevant query-document pairs 308 may therefore be added to training data, which may be fed to a training pipeline 312. Training pipeline 312 may then be used to further refine and fine-tune retrieval model 314, which may be implemented in a RAG bot for document retrieval in a more optimized, efficient, and accurate manner.

However, with unsatisfied data pairs 304, the responses may not include references to the retrieved documents, which may be relevant to the users' queries, or the retrieved documents were not relevant to the users' queries. For example, the previous process may identify data pairs of (query, relevant document), which indicate that the bot response quotes or uses content from the documents, which LLM judge 308 may decipher with relative ease. However, with negative pairs where documents retrieved may be relevant to the user's query but not used or quoted in the documents' response, noise may be introduced if such documents are flagged as not relevant to the user's query. In this regard, LLM judge 308 may be used to process non-relevant query-document pairs 316 and filter for better training data generation. LLM judge 308 may determine the relevance of documents to user queries and only those data pairs where the documents and neither referenced by the response nor relevant to the query may be used as filtered non-relevant query-document pairs 318. Filtered non-relevant query-document pairs 318 may then be further provided in the training data processed by training pipeline 312 for refinement of retrieval model 314.

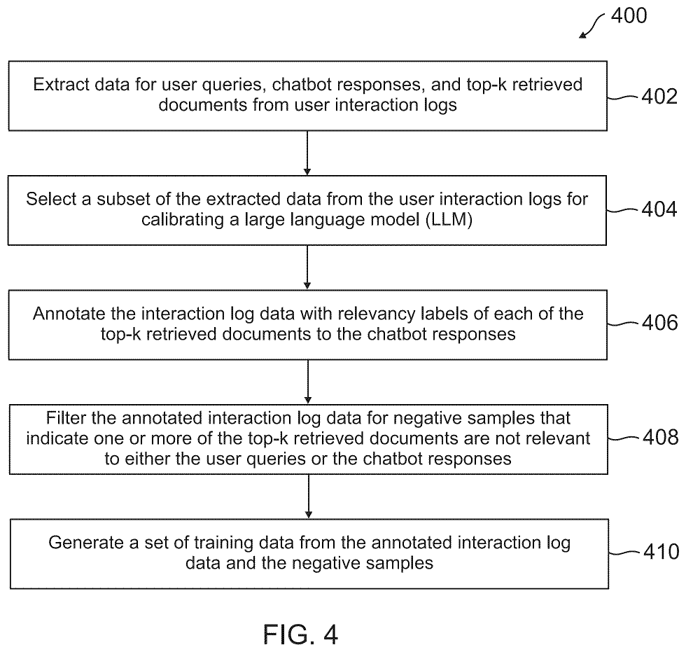

FIG. 4 is a flowchart 400 for identifying relevance of documents for automated retrieval models using large language models, according to an embodiment. Note that one or more steps, processes, and methods described herein of flowchart 400 may be omitted, performed in a different sequence, or combined as desired or appropriate.

At step 402 of flowchart 400, data for user queries, chatbot responses, and top-k retrieved documents is extracted from user interaction logs. Initially, one or more data samples, such as user interaction logs, are accessed and fed to a data extraction module and data processor. This data and/or logs may correspond to chat sessions and/or communication logs, which may be single or multiple sessions and may include asynchronous communications over a time period, that a user may have conducted via their device with an automated chatbot system. The automated chatbot system may utilize LLMs for conversational responses based on a corpus of training documents or other training data, such as a knowledge base used to train the model. Further, the chatbot system may utilize RAG bots and models for document retrieval and answer generation, which may be trained and refined using training data generated from user feedback, as discussed with regard to the following steps. As such, the user interaction logs may include user feedback as well, which may be indicated in such logs and/or subsequent feedback solicitation by the chatbot system and/or user provision.

At an optional step 404, a subset of the extracted data from the user interaction logs for calibrating an LLM is selected. A subset may be selected randomly, using a data sampling operation, or the like, where the subset may be used to calibrate an LLM for generation of data pairs and/or identifying document relevancy to user queries based on user feedback. Once selected, the subset may be annotated by providing a relevancy label of a document to a response, such as using a binary I/O label or the like. When calibrating the LLM, the calibration may be performed as either a prompt update to LLM prompts for the LLM or a supervised fine-tuning of the LLM using the annotated data pairs (e.g., using a fine-tuning technique or retraining algorithm).

At step 406, the interaction log data is annotated with relevancy labels of each of the top-k retrieved documents to the chatbot responses. An LLM may be used to input data pairs representing each bot response and the corresponding document(s) relied upon for that response. In this regard, the data pairs may be input based on whether the bot responses are “satisfying” responses, or adequately answered the user's query, whether the bot responses were “unsatisfying” responses, or did not answer the user's query and/or were otherwise found lacking, and/or those without user feedback, such as if the user did not respond or provide feedback. The LLM may then evaluate whether the document was used and/or referred to in the bot response and therefore may be relevant or irrelevant to the user's query.

At step 408, the annotated interaction log data is filtered for negative samples that indicate one or more of the top-k retrieved documents are not relevant to either the user queries or the chatbot responses. Once the process of steps 402-406 is completed, there may be collection of data pairs, based on those queries corresponding to the bot responses, for user queries and relevant documents, referred to as positive pairs. There may also be data pairs for user queries and irrelevant documents, referred to as negative pairs. For the positive pairs, an LLM may judge whether the document referred to in the response is actually relevant to the user query, which may be done by analyzing the bot response for quotes and/or content from the document. For negative pairs however, documents may be relevant to a user's query but may not be cited and/or used in the bot response such that the bot response does not provide the user with sufficient document information. As such, the negative data pairs are input to an LLM to judge the relevance of the documents to the user query, which may be based on a knowledge base and/or domain knowledge, and only those negative data pairs that do not have the documents relevant to the user query and bot response may be used, referred to as filtered negative pairs.

At step 410, a set of training data is generated from the annotated interaction log data and the negative samples. Once the positive and filtered negative data pairs or other data sample are determined, a training data set may be generated for training and refinement of the corresponding RAG bot. This may then be used through a training algorithm and/or technique to train and/or retrain the corresponding RAG model, such as an ML model for document retrieval. This may provide training based on user feedback, which serves to refine RAG models for better document retrieval. In this regard, user feedback may be used to retrieve better and more accurate documents to user queries, thereby providing an active feedback loop to RAG model training, refinement, and use in LLM chatbot systems.

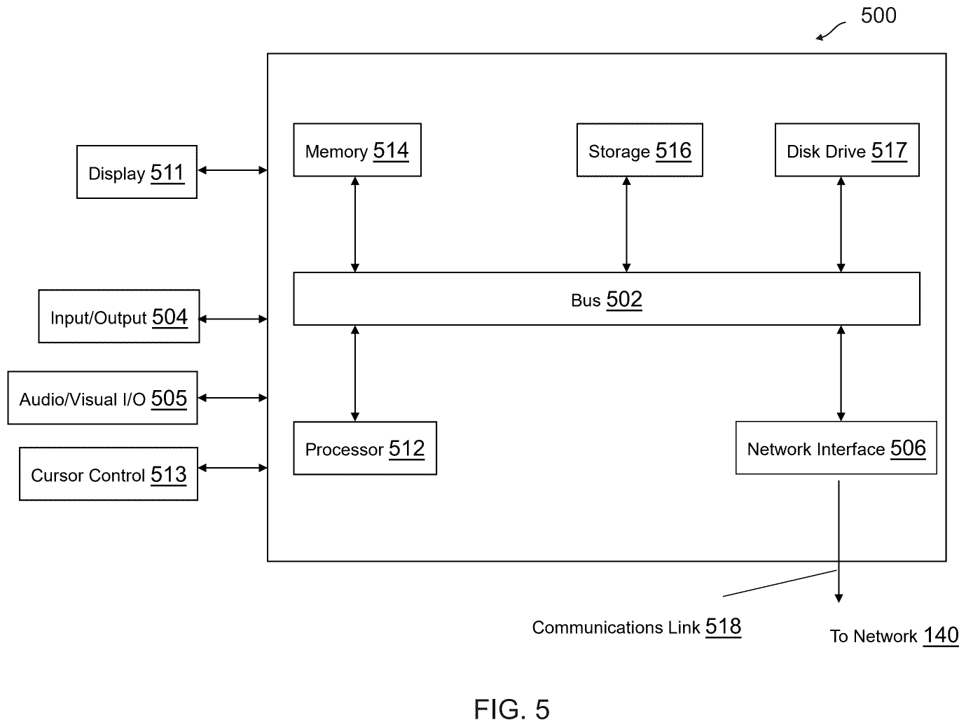

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a log between a user and a chatbot, wherein the chatbot utilizes an automated document retrieval model that is configured to retrieve documents utilized by the chatbot to respond to the user during a chat interaction corresponding to the user interaction log;
extracting, from the log, interaction log data for user queries, chatbot responses, and a set of retrieved documents usable to generate the chatbot responses to the user queries by the chatbot;
annotating the interaction log data with relevancy labels of the set of retrieved documents to the chatbot response using a first large language model (LLM) that evaluates whether each of the chatbot responses references a document from the set of retrieved documents;
filtering the annotated interaction log data using a second LLM that evaluates a document relevancy of each of the set of retrieved documents to the user queries from the interaction log data; and
outputting, to a model training system, training data for a model based on the annotated interaction log data and the filtered interaction log data.

2. The method of claim 1, wherein the model comprises a retrieval augmented generation (RAG) automated bot having a document retriever that retrieves the set of retrieved documents based on the user queries and an answer generator that generates the chatbot responses to the user queries based on the set of retrieved documents.

3. The method of claim 1, wherein the training data comprises positive data pairs and filtered negative pairs generated from the annotating and the filtering, wherein the positive data pairs are associated with one or more of the set of retrieved documents that are determined by the first LLM to be relevant to one or more of the chatbot responses, and wherein the filtered negative pairs are associated with one or more of the set of retrieved documents that are determined by the first LLM to not be relevant to one or more of the chatbot responses and are determined by the second LLM not to be relevant to one or more of the user queries.

4. The method of claim 3, wherein the filtering the interaction log data comprises determining negative samples for the training data that includes the filtered negative pairs based on the first LLM and the second LLM determining that the one or more of the set of retrieved documents are not relevant to either of the one or more user queries or the one or more chatbot responses.

5. The method of claim 1, wherein the relevancy labels comprise one of a positive user response that a first one of the chatbot responses answered a corresponding one of the user queries based on user feedback of the first one of the chatbot responses, a negative user response that a second one of the chatbot responses did not answer a corresponding one of the user queries based on user feedback of the second one of the chatbot responses, or an unknown user response that does not indicate whether a third one of the chatbot responses answered or did not answer a corresponding one of the user queries based on lack of user feedback of the third one of the chatbot responses.

6. The method of claim 5, further comprising:
analyzing the annotated interaction log data that is associated with the unknown user response using the first LLM; and
inferring, based on the analyzing by the first LLM, one of the satisfied user response or the unsatisfied user response in place of the unknown user response.

7. The method of claim 5, wherein the annotating comprises:
scoring, by the first LLM, each of the chatbot responses based on user feedback or user responses to the chatbot responses,
wherein the relevancy labels are annotated to the interaction log data based on the scoring.

8. The method of claim 7, wherein the scoring is performed in response to one or more LLM prompts to the first LLM, and wherein the annotating includes generating the one or more LLM prompts based on the chatbot responses, the set of retrieved documents, and an LLM prompt template.

9. The method of claim 1, wherein, prior to the annotating, the method further comprises:
selecting a subset of the interaction log data usable to calibrate at least the first LLM; and
calibrating the at least the first LLM using the subset of the interaction log data.

10. A system comprising:
a non-transitory memory; and
one or more hardware processors coupled to the non-transitory memory and configured to read instructions from the non-transitory memory to cause the system to perform operations comprising:
extracting, from a user interaction log between a user and a chatbot, a user query, a chatbot response, and a set of documents usable to generate chatbot responses to user queries for the chatbot;
annotating, using a first large language model (LLM), each of the set of retrieved documents with a label indicating whether the chatbot response references each of the set of retrieved documents;
filtering the set of retrieved documents based on whether each of the set of retrieved documents is determined to be relevant to the user query by a second LLM; and
outputting, to a model training system, training data for a document retrieval model of the chatbot based on the annotating and the filtering.

11. The system of claim 10, wherein the annotating comprises:
generating first data pairs each comprising the chatbot response with a document from the set of retrieved documents; and
annotating each of the first data pairs with the relevancy label using the first LLM,
and wherein the filtering comprises:
generating second data pairs each comprising the user query with another document from the set of retrieved documents; and
removing one or more data pairs from the second data pairs based on whether the second LLM determines each document of the set of retrieved documents is relevant to at least one of the user query or the chatbot response.

12. The system of claim 10, wherein the document retrieval model comprises a retrieval augmented generation (RAG) model, and wherein the chatbot includes a document retriever that utilizes the RAG model and an answer generator that utilizes a third LLM to respond to at least the user query.

13. The system of claim 10, wherein the training data comprises positive data pairs and filtered negative pairs generated based on the annotating and the filtering.

14. The system of claim 13, wherein the positive data pairs each indicate that a corresponding document of the set of retrieved documents is referenced by the chatbot response to the user query, and wherein the filtered negative pairs each indicate that a corresponding document of the set of retrieved documents is neither referenced by the chatbot response to the user query nor determined to be associated with the user query by the second LLM.

15. The system of claim 10, wherein the first LLM is configured to determine whether the chatbot response contains a reference to each of the set of retrieved documents.

16. The system of claim 10, wherein the second LLM is configured to determine whether each of the set of retrieved documents is associated with responding to the user query.

17. The system of claim 10, wherein the first LLM and the second LLM are a single LLM, and wherein the operations further comprise:
performing a calibration of the single LLM prior to the annotating and the filtering using a subset of the set of retrieved documents with the chatbot response and one or more annotations.

18. The system of claim 17, wherein the calibration comprises one of an LLM prompt update or a supervised fine-tuning of the single LLM.

19. A method comprising:
generating, using a large language model (LLM) system, first data pairs and second data pairs from data associated with user queries, chatbot responses to the user queries, and retrieved documents by a retrieval model usable for generating the chatbot response, wherein the first data pairs and the second data pairs indicate whether the LLM system determines each of the retrieved documents is referenced by a corresponding one of the chatbot responses;
filtering, using the LLM system, second data pairs from the data based on whether the LLM system determines each of the retrieved documents is a top scored document for responding to a corresponding one of the user queries;
generating training data usable by a retrieval model based on the first data pairs and the filtered second data pairs; and
refining the retrieval model based on the training data.

20. The method of claim 19, further comprising:
prior to the generating the first data pairs and the second data pairs, extracting the data from user interaction logs between users and the chatbot.
